(19) United States
(12) Patent Application Publication
(10) Pub. No.: US 2011/0232501 A1
(43) Pub. Date: Sep. 29, 2011

(54) ELECTRIC MACHINE FOR PREPARING BEVERAGES

(76) Inventors: Klaus Kroesen, Xanten (DE); Marius Hilckmann, Witten (DE); Christian Schmalor, Sundern (DE); Clemens Klueppel, Neuenrade (DE)

(21) Appl. No.: 13/053,316

(22) Filed: Mar. 22, 2011

(30) Foreign Application Priority Data
Mar. 23, 2010 (DE) 102010012562.8

(51) Int. Cl. A47J 31/44; B01F 3/04; A23L 2/54

(52) U.S. Cl. 99/323.1

(57) ABSTRACT

An electric machine for making a beverage has a water heater having an inlet and an outlet, a pump for supplying fresh water to the water-heater inlet so that the water heater can supply heated or vaporized fresh water to the outlet, a port, and a milk supply. A mixer has a steam/water intake, a milk intake, an air intake, and an outlet. A milk conduit is connected between the milk supply and the milk intake and an gas conduit between the port and the air intake. A two-position valve connected to the water-heater outlet, to the gas conduit, and to the steam/water intake of the mixer is movable between a first position feeding steam or hot water from the water heater to the steam/water intake of the mixer and a second position feeding steam from the water heater to the gas conduit.

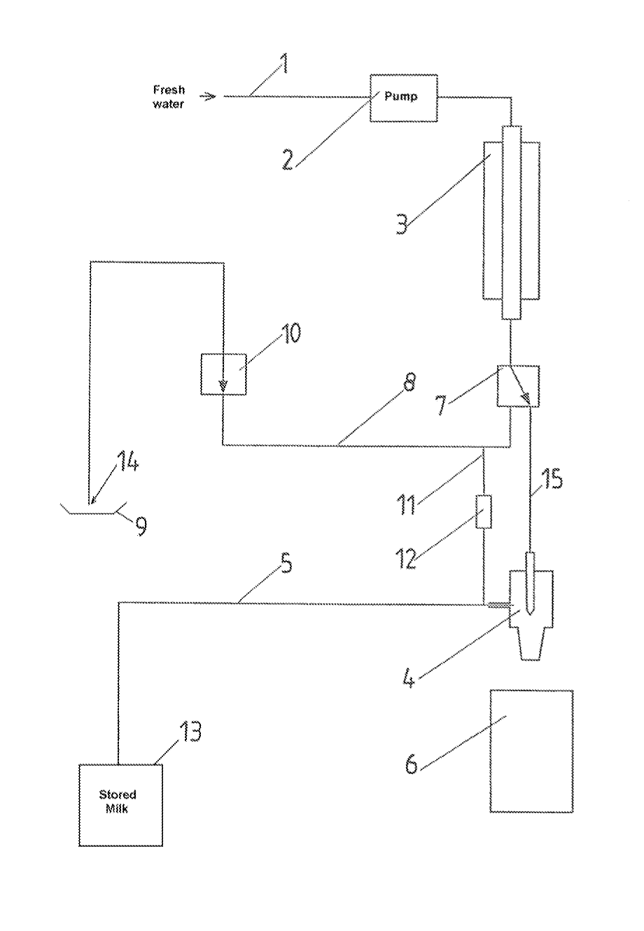

### FIELD OF THE INVENTION

The invention concerns an electric machine for preparing beverages comprising a pump for feeding fresh water, a heater for heating the fresh water, a device for feeding milk, a device for feeding air, a mixer for mixing hot water, steam, milk and/or air, as well as a device for dispensing the mixture to a container, the mixer being connected to the steam or hot water outlet of the heater, and an air supply conduit and a milk supply conduit leading into the mixer.

### BACKGROUND OF THE INVENTION

In the prior art machines for preparing beverages, milk foam is produced by that by means of the electric heater, for instance by means of an instantaneous water heater, by intermittently pumping with the pump feeding fresh water, steam is produced. This steam is supplied to the mixer, for instance an ejector. The ejector is connected to a conduit leading to a container with milk. Through this conduit, milk is sucked in by the ejector. If applicable, another access for feeding air to the ejector is provided, so that by the supplied amount of air the milk foam production can be varied.

Such devices are for instance integrated in a coffee machine, by means of which coffee or another hot beverage can be produced. In the known arrangement, the very small air nozzle will quickly get dirty, since it is directly mounted at the ejector, so that a contamination by milk or milk foam will occur.

Furthermore, at the end of the milk foam production, there is strong and uncontrolled after-dropping of the milk foam, until the heater doesn't produce steam anymore.

### OBJECTS OF THE INVENTION

It is therefore an object of the present invention to provide an improved electric machine for preparing beverages.

Another object is the provision of such an improved electric machine for preparing beverages that overcomes the above-given disadvantages, in particular that avoids strong and uncontrolled pre- and after-dropping during milk foam production.

### SUMMARY OF THE INVENTION

An electric machine for making a beverage has according to the invention a water heater having an inlet and an outlet, a pump for supplying fresh water to the water-heater inlet so that the water heater can supply heated or vaporized fresh water to the outlet, a port, and a milk supply. A mixer has a steam/water intake, a milk intake, an air intake, and an outlet. A milk conduit is connected between the milk supply and the milk intake and an gas conduit between the port and the air intake. A two-position valve connected to the water-heater outlet, to the gas conduit, and to the steam/water intake of the mixer is movable between a first position feeding steam or hot water from the water heater to the steam/water intake of the mixer and a second position feeding steam or hot water from the water heater to the gas conduit.

By providing this two-position valve it is possible to produce milk foam in the standard manner in the first switching position, or also to heat milk by connecting, since then the outlet of the heater is connected with the mixer, and the mixer can correspondingly supply hot milk or milk foam to a vessel. At the end of the milk-heating or -foaming process, the two-position valve can be set into the second position by operating a switch or by an electronic circuit. In this position, the outlet of the heater is connected with the gas conduit outlet that leads to a port above a collecting tray, so that there is no dripping at the outlet of the mixer, but the hot steam and/or the hot water is directly conducted to the collecting tray or the port where it can exit in a trouble-free manner.

In addition, the gas conduit can be provided with a stop valve buy means of which it can be blocked. In a particularly preferred embodiment the gas conduit leading to the port is connected between the stop valve and the two-position valve to a bypass conduit that branches off and is connected with the milk supply conduit and in which a throttle is interposed. This way the throttle is not immediately in the region of the mixer, but relatively far from it, so that it cannot get fouled by milk or milk foam. Air can be supplied through the throttle to the mixer, if milk foam production is desired, or the air supply can be blocked to just produce hot milk. Preferably the throttle is adjustable. Adjustment of the throttle serves for adjusting the proportion of foam to milk. Alternatively, by intermittently switching the valve, the proportion of foam to milk can be adjusted.

In a manner known per se, the mixer is a mixing nozzle of the Venturi type, that is working like a jet pump to aspirate milk and air with a jet of steam.

In the first position of the two-position valve, the stop valve is opened, so that air is conducted through the gas conduit, bypass conduit, and throttle to the mixer. This position corresponds to the mode of operation of the device, in which milk foam is to be produced.

In the second position of the two-position valve, the stop valve is opened so that hot steam is conducted through the stop valve to the port.

A change over to this second position is made when milk foam production is terminated, so that then the steam remaining in the machine is not conducted anymore through the mixer, but through the stop valve to the port where it is vented.

Another special feature is that in the first position of the two-position valve, the stop valve is closed so that all the steam flows without air enrichment to the mixer. This way, in operation of the device, milk is only heated, without being enriched with air, i.e. no milk foam is generated.

In another configuration, in the second position of the two-position valve, the stop valve is closed and hot water is conducted through the throttle to the mixer and thereafter or alternatively the two-position valve is set to the first switching position, so that hot water is directly conducted to the mixer. In this mode of operation, the throttle is cleaned by hot steam or hot water, and thereafter or alternatively the two-position valve is set to the first switching position, so that then the hot water is directly conducted to the mixer. For cleaning purposes, this configuration is advantageous, for instance first hot water being conducted for a short time through the throttle to the mixer and then hot water being only conducted through the mixer, the residual water possibly still present in the throttle being also sucked in, so that the throttle is cleaned.

Still another special feature is that the two-position valve and/or the stop valve is a solenoid valve.

Preferably, the cleaning of the system should be made after every milk foam production.

The different processes can be activated by operation of switches by the user. It is however also possible that the different switch states are automatically set by an electronic controller, when the user activates an operating program “milk foam production” or an operating program “hot milk production” or an operating program “cleaning.”

### BRIEF DESCRIPTION OF THE DRAWING

The above and other objects, features, and advantages will become more readily apparent from the following description, reference being made to the accompanying drawing whose sole FIGURE is a schematic diagram of an electric beverage-making apparatus according to the invention.

### DETAILED DESCRIPTION

As seen in the drawing, where only the essential elements of the machine for preparing beverages are shown and described, a beverage-making machine is connected by a water conduit 1 to a water tank or to a water reservoir, so that fresh water can be supplied through the conduit 1. The fresh water is sucked in by a pump 2 integrated in the conduit 1 and is then pumped into an electric heater 3, which is for instance an electric instantaneous water heater. In the heater 3, steam is produced that is then conducted through a seam-water conduit to a steam/hot-water intake of a mixer 4. This mixer 4 is connected through a milk conduit 5 to a milk storage container 13, so that milk can be sucked in through the conduit 5 into a milk intake of the mixer 4. In addition, the mixer 4 takes in air, so that the supplied milk mixed with steam and air exits as foam at the dispensing opening of the mixer and drops into a vessel 6.

According to the invention, a two-position valve 7 is interposed in the conduit 15 between the heater 3 and the mixer 4. In a first position shown in the drawing for making foamed or hot milk it connects the outlet of the heater 3 only with the steam/hot-water intake of the mixer 4. In a second alternative position not shown in the drawing for either cleaning the system or venting steam, the outlet of the heater 3 is connected through the two-position valve 7 with an gas conduit 8 leading to a port 14 opening above a collecting tray 9. A blocking or stop valve in the conduit 8 leading to the port 14 can block the conduit 8 for heating milk in the first position of the valve 7 or can be opened for foaming milk in the first position of the valve 7 or for cleaning the system in the second position of the valve 7, as described below in more detail.

Furthermore, a bypass conduit 11 branches off the conduit 8 opening into at the port 9 between the stop valve 10 and the two-position valve 7. This conduit 11 is connected with the milk supply conduit 5, and a throttle valve 12 is provided in it. The throttle valve 12 preferably is adjustable. The mixer 4 preferably is a mixing nozzle of the jet-action Venturi type.

If milk foam is to be produced, the two-position valve 7 is set to the first position and the stop valve 10 is opened. Water steam flows from the heater 3 through the two-position is valve 7 to the mixer 4. Simultaneously, air is drawn in from the port 9 through the conduit 8, the open stop valve 10, the conduit 11, and the throttle valve 12 so that air this is sucked into the mixer 4 together with milk that is sucked in through the conduit 5. Thus the milk intake and air intake basically the same port.

When milk foam production is terminated, the two-position valve 7 is shifted to the second position. The stop valve 10 remains opened. Residual hot steam from the heater 3 is all directed through the conduit 8 and the stop valve 10 to the tray 9.

If only the heating of milk is desired, the two-position valve 7 is set in the first position shown in the drawing, and the stop valve 10 is closed. Thus steam flow produced by the heater 3 is all fed to the mixer 4 that sucks milk in through the conduit 5. Air is not admitted by the closed valve 10, so that no foam is generated but the aspirated milk is heated with the steam.

For cleaning the system, the heater 3 outputs hot water, not steam. The two-position valve 7 is set to the second position and the valve 10 is closed so that the hot water passes through the throttle 12 to the mixer 4. This preferably occurs over a relatively short period of time. Thereafter or alternatively the two-position valve 7 is set to the first switching position, so that the hot water produced by the heater 3 is fed directly to the mixer 4 and rinses it while simultaneously also aspirating any residual water still in the throttle 12 preferably the stop valve 10 open.

The functions can be summarized as follows:

| Function | Valve 7 position | Valve 10 position |
|---|---|---|
| Foam milk | First | Open |
| Heat milk | First | Closed |
| Vent steam | Second | Open |
| Clean system | Second | Closed |

With the arrangement according to the invention, a contamination of the throttle 12 or of the small air nozzles is prevented, and the milk foam is prevented from dripping after termination of the milk-foam production process, since residual steam does not drip off the mixer 4, but is conducted through the additional conduits to the collecting tray 9.

The invention is not limited to this embodiment, but is in many ways variable within the scope of the disclosure. All novel individual or combined features disclosed in the description and/or drawing are deemed essential for the invention

We claim:

1. An electric machine for making a beverage, the machine comprising:
a water heater having an inlet and an outlet;
a pump for supplying fresh water to the water-heater inlet, whereby the water heater can supply heated or vaporized fresh water to the outlet;
a port;
a milk supply;
a mixer with a steam/water intake, a milk intake, an air intake, and an outlet;
a milk conduit connected between the milk supply and the milk intake;
an gas conduit connected between the port and the air intake; and
a two-position valve connected to the water-heater outlet, to the gas conduit, and to the steam/water intake of the mixer and movable between a first position feeding steam or hot water from the water heater to the steam/water intake of the mixer and a second position feeding steam from the water heater to the gas conduit.

2. The electric beverage-making machine defined in claim 1, further comprising
a closable blocking valve in the gas conduit.

3. The electric beverage-making machine defined in claim 2, further
a bypass conduit connected to the gas conduit between the blocking valve and the two-position valve and opening into the milk conduit; and
a throttle in the bypass conduit.

4. The electric beverage-making machine defined in claim 3 wherein the throttle is adjustable.

5. The electric beverage-making machine defined in claim 3 wherein, in an open position of the blocking valve and the first position of the two-position valve, air is drawn through the gas conduit into the mixer.

5. The electric beverage-making machine defined in claim 3 wherein, in a closed position of the blocking valve and the second position of the two-position valve, steam or water flows from the water-heater outlet to the mixer through the throttle and branch conduit.

6. The electric beverage-making machine defined in claim 3 wherein in the closed position of the blocking valve and the first position of the two-position valve, only hot water or steam is fed with milk to the mixer.

7. The electric beverage-making machine defined in claim 3 wherein the blocking valve is a solenoid valve.

8. The electric beverage-making machine defined in claim 1 wherein the two-position valve is a solenoid valve.

9. The electric beverage-making machine defined in claim 1 wherein the mixer includes a Venturi-type mixing nozzle.
